(19) United States
(12) Patent Application Publication
(10) Pub. No.: US 2004/0204168 A1
(43) Pub. Date: Oct. 14, 2004

(54) Headset with integrated radio and piconet circuitry

(75) Inventor: Juha P. Laurila, Halikko (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/390,441

(22) Filed: Mar. 17, 2003

(51) Int. Cl. H04Q 7/20; H04M 1/00

(52) U.S. Cl. 455/569.1; 455/422.1

(57) ABSTRACT

A portable headset 30 has a speaker 42, a radio receiver 32, and PAN circuitry 50 for receiving wireless electrical signals over a piconet such as Bluetooth. The radio receiver 32 or the PAN circuitry 50 may drive the speaker 42, and override circuitry 68 enables the PAN circuitry 50 to mute the radio receiver 32. The headset 30 may have a microphone 52. A mobile phone call incoming to a mobile phone 46 automatically causes a speech connection over the PAN to be established between the mobile phone 46 and the headset 30. The radio receiver 32 is muted and the user 44 carries on a phone conversation through the headset 30 without manually turning off the radio. Muting may be ceased upon termination of the phone call or of the PAN connection. A mobile phone user interface 56 may be used to control the radio receiver 32.

### TECHNICAL FIELD

These teachings relate generally to wireless communication devices that use a personal area network (PAN) such as the Bluetooth protocol. It is particularly related to a headset that integrates a radio headset with circuitry to communicate via the PAN with another device such as a mobile terminal or phone.

### BACKGROUND

As consumer electronics become more ubiquitous, personal area networks (PANs) or piconets are being employed to facilitate the use of multiple devices that can automatically synchronize and communicate with one another over the piconet. Bluetooth (BT) is one radio-frequency protocol by which electronic devices are connected to one another over short-range radio links, and operates in the unlicensed ISM (industrial, scientific, medical) band at about 2.4 to 2.5 GHz. Low power (about 1 mW) limits the range of a Bluetooth network to about 10 meters, and spread spectrum frequency hopping (changing frequencies ˜1,600 times per second) limits interference from other devices using the ISM bandwidth (e.g.: garage door openers, baby monitors, devices using a different Bluetooth piconet).

Headsets employing piconets in general and Bluetooth in particular are known in the art. Specifically, a BT headset may be combined with a mobile terminal or cellular phone. The headset includes headset Bluetooth circuitry that transmits and receives signals from the piconet. The mobile terminal, referred to herein as an audio gateway (AG) transmits and receives via AG BT circuitry that is synchronized with the headset BT circuitry to communicate via the PAN. Incoming transmissions, such as incoming audio from a cellular/PCS phone call, are received by the mobile terminal and transmitted over the PAN to the headset, which drives the speaker. The headset may include a microphone that converts a user's spoken audio to an electronic signal that is sent by the headset BT circuitry over the PAN, and received by the AG BT circuitry to be sent via a cellular, PCS, or similar telecommunications network.

There is a desire among consumers for a headset that enables communications with a mobile terminal as above and that also receives FM or AM radio transmissions when the mobile terminal is not active (i.e.: no active phone call). Specifically, it would be very desirable for a consumer to have his or her listening to AM or FM radio interrupted automatically when two-way communication over a network other than the PAN is initiated, such as an incoming cellular phone call. It would also be preferable that listening to AM or FM radio at the headset is resumed when such two-way communication is terminated. It would be a critical consideration that such a system not draw power from batteries within the BT headset to such an extent as to significantly shorten battery life between chargings, as compared to current BT headsets.

### SUMMARY OF THE PREFERRED EMBODIMENTS

The foregoing and other problems are overcome, and other advantages are realized, in accordance with the presently preferred embodiments of these teachings. In accordance with one aspect of the present invention, a portable audio device such as a headset that is wearable by a user includes a first transducer for converting electrical signals to acoustic signals, such as a speaker, and a radio receiver for receiving wireless radio transmissions. The radio receiver drives the speaker under certain conditions. The audio device also includes personal area network (PAN) circuitry. The PAN circuitry includes circuitry for transmitting and receiving a PAN signal over a piconet, override circuitry for interrupting a signal from the radio receiver to the first transducer (i.e.: muting the radio receiver's signal to the speaker), and circuitry for driving the speaker with an electrical signal corresponding to a PAN audio signal.

In accordance with another aspect of the present invention, a communication system includes a portable audio device and an audio gateway. The audio device includes a first transducer for converting electrical signals to acoustic signals, such as a speaker, and a radio receiver for receiving wireless radio transmissions such as AM or FM radio broadcasts. The radio receiver drives the speaker except in certain circumstances. The audio device also includes headset PAN circuitry, and the PAN circuitry includes circuitry for transmitting and for receiving PAN signals over a piconet, override circuitry for interrupting a signal from the radio receiver to the first transducer (i.e.: muting the radio receiver's signal to the speaker), and circuitry for driving the first transducer with an electrical signal corresponding to a PAN audio signal. The audio gateway may be a mobile phone and includes a second transducer for converting acoustic signals to electrical signals, such as a microphone. The audio gateway also includes PAN circuitry for transmitting and for receiving PAN signals over the piconet, and the audio gateway PAN circuitry is connected to the microphone.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a schematic overview of a preferred embodiment of the present invention, a headset, in context with other communication devices and networks.

FIG. 2A is a first alternative embodiment wherein the housing defines a wing for securing a single speaker to a user's ear.

FIG. 2B is a second alternative embodiment, wherein the housing is an earpiece that extends into a canal defined by a user's ear.

FIG. 2C is the third alternative embodiment, wherein the speaker is external of the housing and connected thereto by a flexible wire.

FIG. 3 is a block diagram of the headset of FIG. 2A-2C.

FIG. 4 is a process diagram showing data flow for FM muting between an Audio Gateway (AG) and a headset of the present invention.

FIG. 5 is a block diagram of the headset of FIG. 1 that includes a microphone.

FIG. 6 is a simplified block diagram of a handsfree headset of the present invention such as that shown in FIG. 1.

FIG. 7 is a process diagram showing data flow for FM muting between a handsfree headset of the present invention and an AG does not support call setup indicators.

FIG. 8 is a process diagram similar to FIG. 7, but wherein the AG does support call setup indicators.

FIGS. 9A-9E are sections of a continuous vertical process diagram showing data flow for various actions taken at a remote user interface or a FM user interface on a headset of the present invention.

### DETAILED DESCRIPTION OF THE PREFERRED EMBODIMENTS

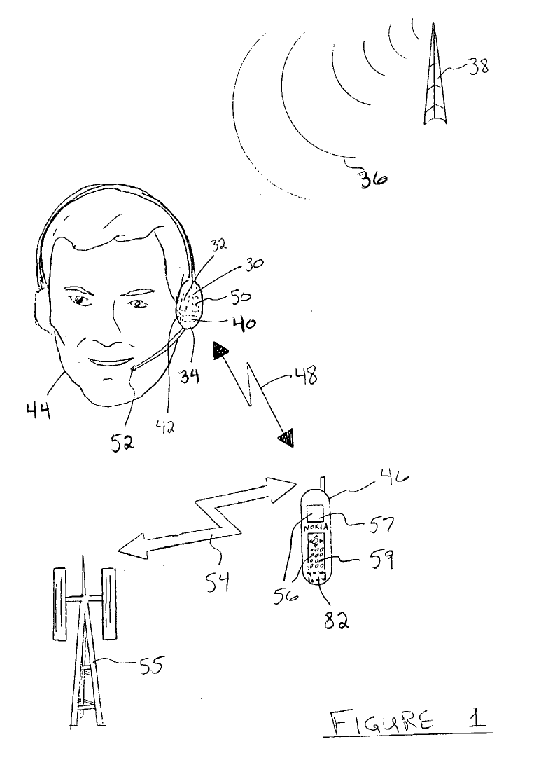

FIG. 1 illustrates an overview of a preferred embodiment of the present invention, a headset 30 shown in context with other communication devices. The headset 30 includes a radio receiver 32 within a housing 34 for receiving radio transmissions 36 such as AM or FM radio broadcasts from a radio transmitting station 38. As known in the art, the radio receiver 32 is powered by a battery 40 and drives an electrical to acoustic transducer such as a speaker 42 placed near an ear of a user 44 so that the user can listen to, for example, AM talk or FM music. An audio gateway (AG) 46 such as a mobile phone is in close proximity to a user so that the AG can communicate over a personal area network (PAN, also known as a piconet or piconetwork) via a PAN link 48 with headset PAN circuitry 50 that is located within the housing 34 of the headset 30. The AG 46 must also incorporate AG PAN circuitry 82 that is synchronous with the headset PAN circuitry 50. Both the headset PAN circuitry 50 and the AG PAN circuitry 82 have the capability to transmit and receive signals over the PAN. The headset 30 may optionally be connected to an acoustic to electrical transducer such as a microphone 52.

Piconet and PAN as used herein is any network defined by a limited wireless range, typically less than, for example, about 20 meters. A piconet or PAN is not limited to radio-frequency networks but may employ other means of transmission (such as optical, as in a localized infrared network). Preferably, the PAN employs the Bluetooth (BT) radio frequency (RF) standard having a wireless range limited to about 10 meters, but the present invention is not limited to any particular RF standard or even RF networks in general. The terms PAN, piconet, and Bluetooth are used herein interchangeably except where context makes clear that the term Bluetooth is limited to only that particular RF standard. The Bluetooth specification, version 1.1, is herein incorporated by reference.

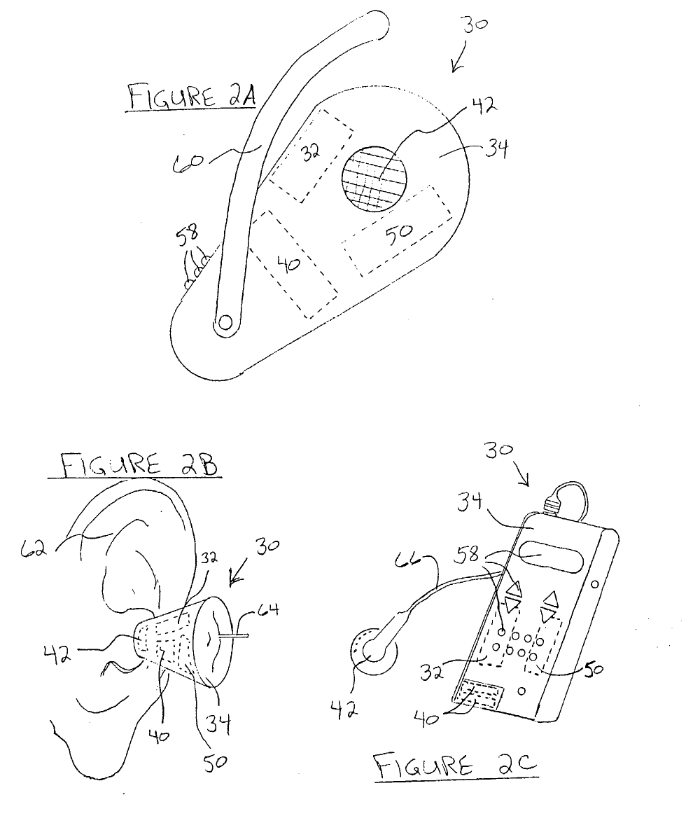

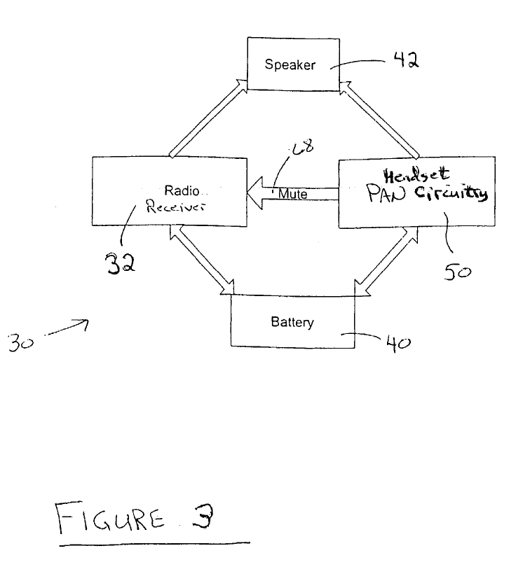

The AG 46 may communicate over a cellular/PCS RF link 54 with a base station 55 of a wireless cellular/PCS network as known in the art. The AG 46 is any device that transmits and receives wireless signals over a network having a range substantially larger than the range of the PAN. AGs include mobile terminals, cellular/PCS phones, wireless intercoms, personal digital assistants with wireless phone capability, two-way radios, walkie talkies, and the like. The AG 46 includes an AG user interface (AG UI) 56, preferably an LCD screen 57 to display data and a series of buttons 59 or a touch-sensitive pad, whereby the user 44 can manually input data or commands to the AG 46. The headset 30 may optionally include a headset user interface (UI) (58 of FIG. 2C), preferably a series of buttons and an LCD screen to display data.

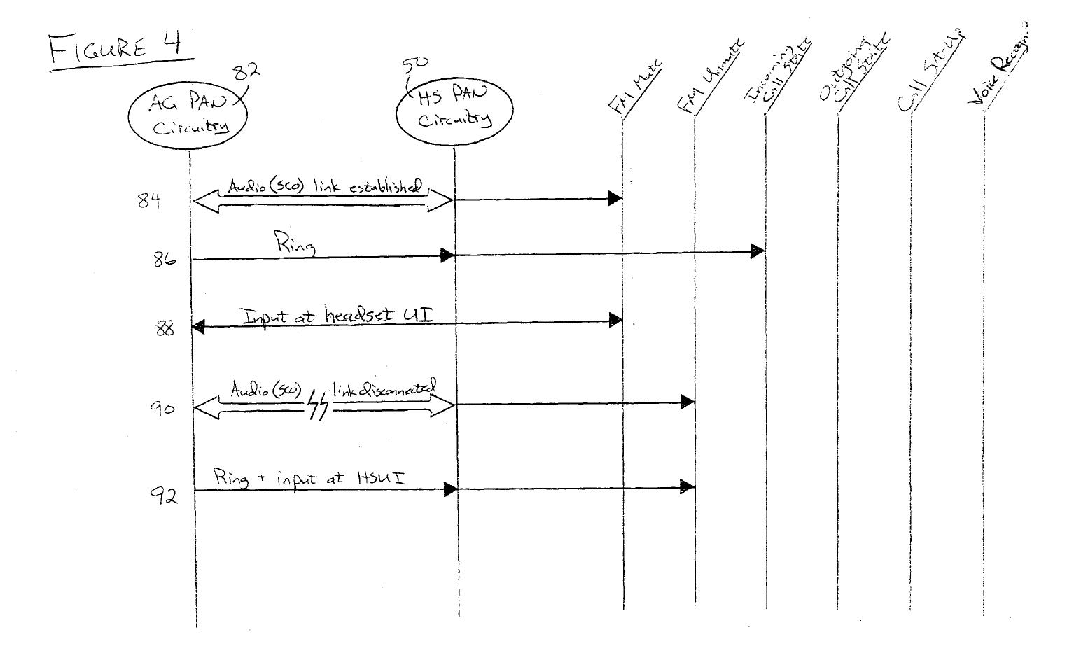

The user 44 may be listening to FM radio via the radio receiver 32 and speaker 42 in the headset 30. Preferably, a wireless PAN link 48 is established anytime the AG 46 and the headset 30 are both powered and within piconet range of one another. The AG 46 may then receive an incoming phone call over the cellular RF link 54, and in response, establish an audio connection 84 (see FIG. 4) with the headset PAN circuitry 50. The headset PAN circuitry 50 mutes FM radio to the speaker 42 by blocking, attenuating, or turning off a signal from the radio receiver 32. The headset PAN circuitry 50 then drives the speaker 42 with at least a portion of the wireless signals received from the AG 46 over the PAN link 48. In this manner, the user 44 can hear a ring, tone or beep over the speaker 42 indicating that a call is incoming without the distraction of simultaneously listening to the FM transmission 36, and the user 44 does not need to manually access the headset UI (not shown) to adjust or turn off the FM radio portion of the headset. In certain embodiments, the user 44 may carry on a mobile phone call via the headset while FM listening is automatically muted.

Each of the FIGS. 2A to 2C represent alternative embodiments of a headset according to the present invention, each without a microphone 52, wherein the radio receiver 32, the battery 40, and the headset PAN circuitry 50 function as previously described. FIG. 2A is a first alternative embodiment wherein the housing 34 defines a wing 60 for securing the single speaker 42 to a user's ear. The headset UI 58 is a series of buttons, and the user 44 would have to remove the speaker 42 from his ear to view any visual display that may form a portion of the headset UI 58. FIG. 2B is a second alternative embodiment, wherein the housing 34 is a hearing-aid style earpiece that extends into a canal defined by a user's ear 62. An external antenna 64 receives both broadcast radio transmissions 36 and transmissions over the PAN link 48. Due to the small size of the embodiment of FIG. 2B, the external antenna 64 may be used as a handle for inserting and removing the headset 30 from a user's ear 62. There is no headset UI in the embodiment of FIG. 2B. FIG. 2C represents the third alternative embodiment, wherein the speaker 42 is external of the housing 34 and connected thereto by a flexible wire 66. The housing 34 is preferably carried in a user's pocket or clipped to his or her belt. The embodiment of FIG. 2C depicts a single speaker 42, but two may be used for stereo listening. The headset UI 58 includes a series of buttons and an LCD display screen, which the user can view without removing the speaker 42 from his or her ear 62.

FIG. 3 depicts in simplified block diagram form a headset 30 according to the present invention. The headset PAN circuitry 50 receives signals from and preferably also transmits signals to at least one other device (not shown), such as an AG, employing synchronous AG PAN circuitry 82 over the piconet. The headset PAN circuitry 50 and the radio receiver 32 are each connected to the speaker 42 so that either may drive the speaker 42 independently of one another. The headset PAN circuitry 50 and the radio receiver 32 may be segregated modules or components, or they may be intertwined or separated circuitry that may or may not share a common substrate such as a printed wiring board. The headset PAN circuitry 50 includes override circuitry 68 for interrupting the radio receiver's 32 ability to drive the speaker 42 under certain circumstances, such as circuitry to mute a signal from the radio receiver 32 to the speaker 42. Preferably, the radio receiver 32 and the headset PAN circuitry 50 are electrically powered by a common battery 40 disposed within the housing 34, or by a common plurality of batteries. Alternatively, the receivers 32 and 50 may be powered by separate batteries.

FIG. 4 is a process diagram showing communications over the piconet between an audio gateway (AG) 46 and a headset 30 according to an embodiment of the present invention that does not include a microphone. The user may employ a microphone of the AG 46 for two-way mobile communications. The AG 46 is equipped with AG PAN circuitry 82 that is synchronized with the headset PAN circuitry 50.

As is known in the Bluetooth protocol, a PAN link 48 (FIG. 1) is preferably established anytime the AG 46 and the headset 30 are both powered and within range of one another. The PAN link 48 becomes an audio link such as a synchronous connection oriented (SCO) link (line 84) between the AG PAN circuitry 82 and the headset PAN circuitry 50 under certain conditions, such as when a call is incoming to the AG 46 over a mobile RF link 54 (FIG. 1). When the SCO link is established (line 84), the headset PAN circuitry 50 employs override circuitry 68 (FIG. 3) to interrupt signals from the radio receiver 32 to the speaker 42 (i.e.: FM mute). Preferably, this is done by muting signals from the radio receiver 32 to the speaker 42, or alternatively by turning off the radio receiver 32. Once the SCO link is established (line 84), a ring (line 86) at the AG will cause the AG PAN circuitry 82 to transmit over the piconet a ring or a tone to the headset PAN circuitry 50. In response, the headset PAN circuitry 50 continues to mute radio signals to the speaker 42 and also signals an incoming call state to other circuitry within the headset 30, which may configure certain inputs at the headset UI to perform functions not associated with other states. In accordance with line 88, while an SCO link is established and a user makes a specific input at the headset UI (for example, depressing a button), the headset PAN circuitry 50 informs the AG PAN circuitry 82 to route the call through the headset. Signals from the radio receiver to the speaker 42 continue to be muted.

The radio receiver's signal to the speaker 42 may be restored (unmuted), for example, under either of two separate circumstances while the headset is in the incoming call state. The first instance is illustrated at line 90 when the SCO link is disconnected, such as when the AG is moved beyond the piconet range of the headset. In this case, the headset may automatically cease interrupting (muting) signals from the radio receiver 32 to the speaker 42 (FM unmute). The second instance is represented at line 92 when a user makes an input at the headset UI after the headset enters the incoming call state. For example, a user may choose not to receive an incoming call after viewing a cller ID on the screen of the headset or the AG. Consequently, the user may depress a button on the headset that restores (unmutes) FM radio sounds to the speaker, perhaps allowing a voicemail system to answer the incoming call. The latter instance disconnects the audio link while leaving a more generalized PAN link 48 intact.

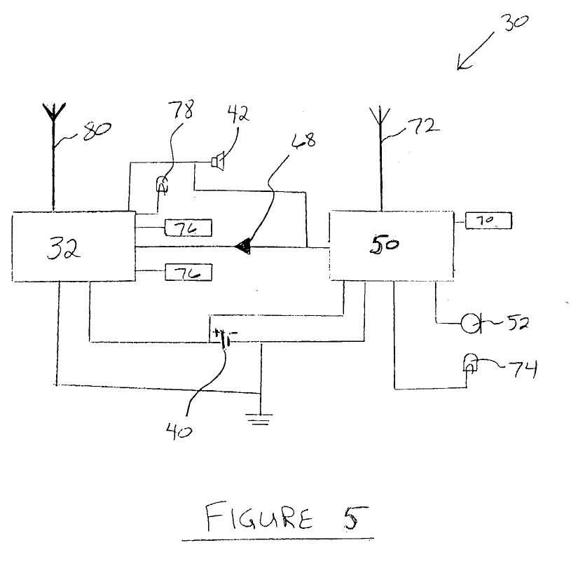

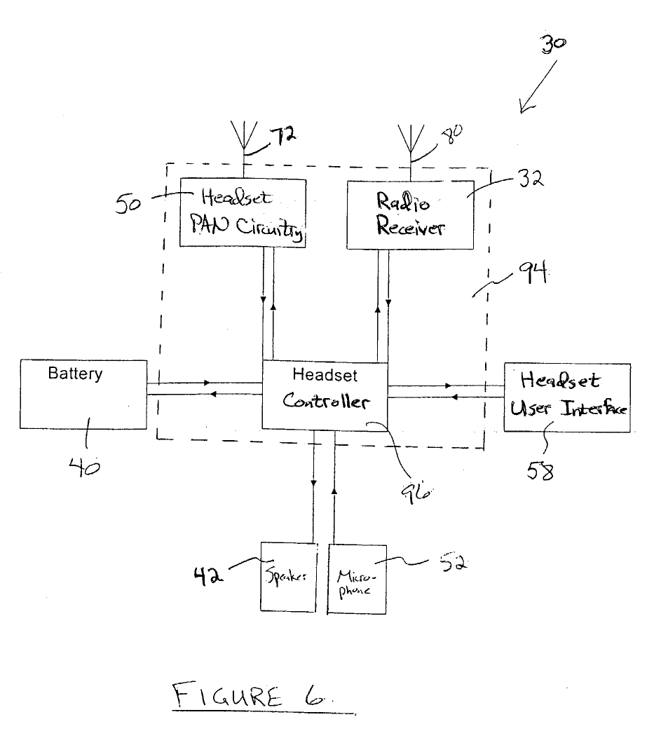

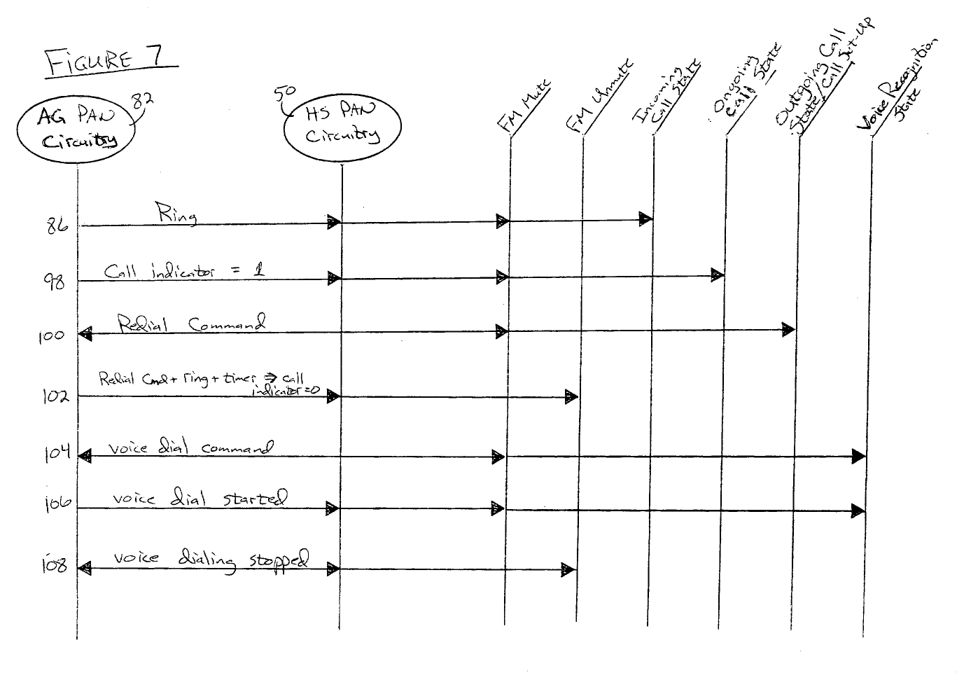

In order to maximize options for a user 44 according to the present invention, a headset 30 incorporating a microphone 52 (i.e., a handsfree headset) is preferred. As an added convenience for a user 44, a handsfree headset 30 may include the ability to transmit status data over the piconet corresponding to the radio module 32, such as on/off, stereo/mono, channel, frequency, common station name, call status, etc. This convenience integrates the headset UI 58 with the AG UI 56, so that some or all aspects of the headset may be controlled through the AG UI 56. Such a handsfree headset 30 may exclude a headset UI 58 altogether, or only parts thereof. FIGS. 5 through 9E depict details of the handsfree headset embodiment.

FIG. 5 depicts in block diagram a handsfree headset 30, such as that in FIG. 1, in more detail. The handsfree headset 30 includes an acoustic to electrical transducer such as a microphone 52 connected to the headset PAN circuitry 50. The headset PAN circuitry 50 further includes a PAN antenna 72, and optionally may include one or more headset PAN controls 70 accessible by a user and/or a PAN display 74 (such as an indicator light). Similarly, the radio receiver 32 includes a radio antenna 80, and may optionally include one or more radio controls 76 (such as volume and frequency adjust) and/or a radio display 78 (such as an alpha-numeric frequency display and a stereo indicator light). The headset PAN controls 70, the PAN display 74, the radio controls 76, and the radio display 78, or whichever of them are present, are each components of the headset UI 58 previously described. The radio antenna 80 may or may not be identical with, or co-located with, the PAN antenna 72. Preferably, a single battery 40 provides power to both the headset PAN circuitry 50 and the radio receiver 32. The battery 40 may be charged through the headset PAN circuitry 50 by a power source (not shown) external of the headset 30, and controlled by software resident in the headset PAN circuitry 50. In other embodiments, any suitable battery recharging scheme (i.e.: solar, gyroscopic motion) can be employed, or the battery can be a non-rechargeable type of replaceable battery.

FIG. 6 is a simplified block diagram of the handsfree headset 30 wherein the headset PAN circuitry 50 and the radio receiver 32 are mounted to a common printed wiring board (PWB) 94. Preferably, a headset controller 96 is included that carries a processor, memory and software to enable some or all of the additional functionalities described with reference to a handsfree embodiment. The headset controller 96 preferably also controls charging of the battery 40. The battery 40, speaker 42 and microphone 52 are as previously described. A headset UI 58 may optionally be employed on a handsfree headset 30. Where the headset UI 58 is employed, the handsfree headset 30 preferentially includes software, a local control unit (e.g.: a microprocessor) and memory to store pre-set radio data such as channel, frequency, station name, volume level, etc. Where all functions are controllable from an AG UI 56, no such additional memory or software in the handsfree headset 30 is required since such data may be stored in and accessed from within the AG 46 via the piconet whenever the AG 46 is within piconet range and powered ON. The term “remote user interface (UI)” refers to an interface of the AG being used to control headset functions, especially radio receiver (i.e.: FM) functions, and may be used regardless of whether the headset 30 includes its own headset UI 58.

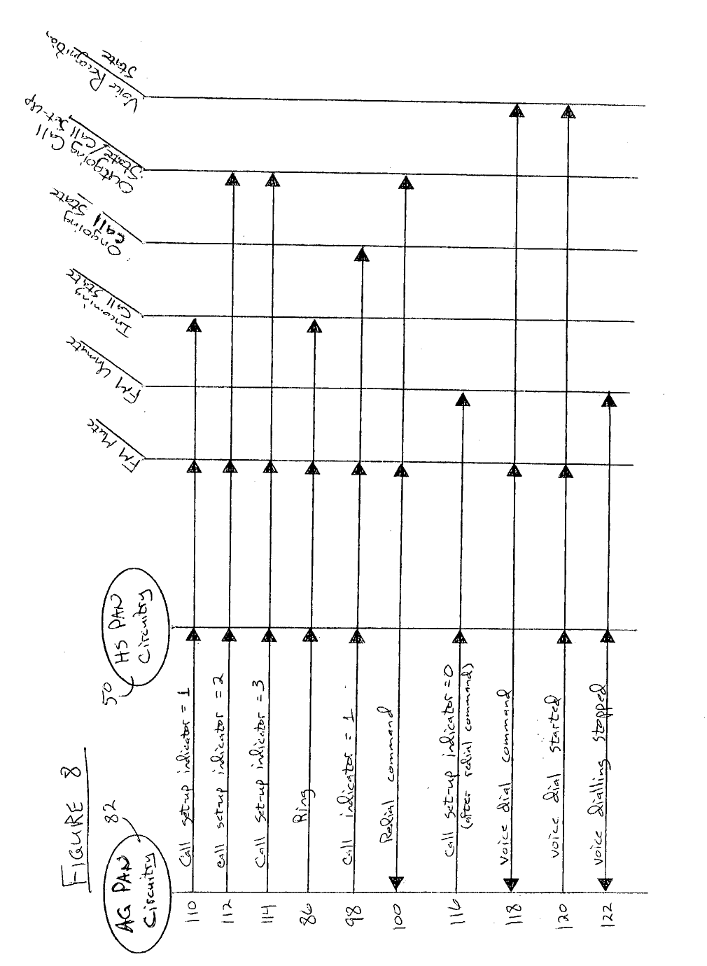

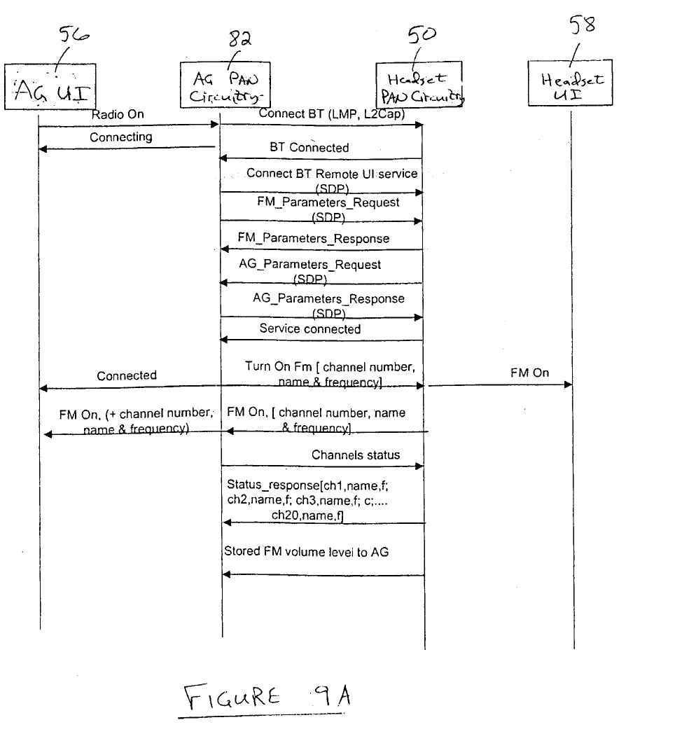

FIGS. 7 and 8 are process diagrams illustrating how radio (FM) muting works when the AG 46 does or does not support call setup indicators, respectively. A call indicator and a call set-up indicator is an electronic status of the AG 46 that sets up circuitry for a particular function. Certain of these, described with reference to FIGS. 7 and 8, are signaled from the AG 46 to the headset 30 to facilitate seamless operation. In the example described herein, there are two call status states: a mobile call with the AG 46 is either established (an ongoing call between two users, depicted as call indicator=1) or there is no mobile call (a mobile call is not ongoing between two users, depicted as call indicator=0). In the example described herein, there are four call set-up status states: no call set-up (either an established call or no call; depicted as call set-up indicator=0); incoming call state (an incoming call that has not yet been established at the AG 46, such as when the AG 46 rings but is not yet answered; depicted as call set-up indicator=1); outgoing call set-up state (the AG 46 is preparing to initiate a mobile call but has not yet established communications over an RF link 54 with a base station 55, such as when a user 44 has depressed a send button but the remote party has not yet been alerted; depicted as call set-up indicator=2); and outgoing call state (an outgoing call is being made from the AG 46 and an RF link 54 has been established but the call has not yet been answered at the receiving end; depicted as call set-up indicator=3). Certain of these states and statuses may be displayed for a user on a display screen at the AG 46 and/or the headset 30 (i.e.: “connecting”, “Joe Smith, 123-4567”, “in use”, “signal lost”, etc.).

Preferably, the handsfree headset 30 delivers an audible tone or beep to the speaker 52 anytime an SCO link is established 84 or disconnects 90, as described above with reference to FIG. 4. Each of the horizontal lines between the AG PAN circuitry 82 and the headset PAN circuitry 50 represents data that flows over the SCO link between them. Each horizontal line to the right of the headset PAN circuitry 50 represents actions/status changes within the headset 30. Unlike FIG. 4, FIG. 6 represents an AG 46 that supports call indicators (though not call set-up indicators), and wherein the headset 30 is handsfree capable (i.e.: includes a microphone). As described in FIG. 4, a call incoming to the AG 46 when an SCO link is established causes the AG PAN circuitry 82 to send a ring signal (line 86) to the headset PAN circuitry 50, which causes the headset PAN circuitry to mute radio signals to the speaker (FM mute). The ring tone heard at the speaker 42 may be generated by the AG 46 or by the headset 30. Some action by the user is then required to answer the call, either at the AG UI 56 or at a headset UI 58, if present. The headset 30 may support caller identification, whereby the caller's name and/or number may be displayed on a UI 56, 58 that includes an alpha-numeric display. Depending on the size of this headset display, scrolling may be used to view the entire name/number.

Line 98 (call indicator=1) depicts operation when the AG PAN circuitry 82 informs the headset PAN circuitry 50 by a call indicator that a call is established (i.e.: when the user answers the incoming call, such as by depressing a button on the AG UI 56). Upon receipt of that call indicator, the headset PAN circuitry 50 continues FM mute and configures the headset circuitry to an ongoing call state so that the user can both talk and listen to the phone call over the headset.

Line 100 depicts a redial command from the headset to the AG 46, and is typically initiated by an input 108 at the UI 56, 58. In this instance, the headset PAN circuitry 50 commands the AG PAN circuitry 82 to redial, and the AG 46 dials the last dialed number. This feature is particularly useful where a cellular RF link has been inadvertently broken, such as when one of the two parties to an ongoing call enter an area of weak cellular RF signal 54 strength. The headset PAN circuitry 50 further mutes the radio (FM mute) and configures the headset circuitry to an outgoing call state and sets up a call for handsfree operation via the headset once the call is established.

Line 102 represents the situation where the redial procedure of line 100 has not resulted in a connected call. After the redial command and several rings at the receiving end of the call cause a timer in the AG to expire, and the AG call indicator still indicates no established call (call indicator=0), the AG PAN headset 82 sends a signal to the headset PAN circuitry 50, which unmutes the radio (FM unmute). Each unmuting of the radio restores the radio to its status quo ante (i.e.: the radio receiver driving the speaker at a frequency and volume previously selected prior to muting.

Where the AG 46 supports voice recognition, line 104 represents voice dialing initiated from the headset, such as by depressing a button on a UI 56, 58, placing a microphone boom in position and speaking a recognizable command, etc. In this instance, the headset PAN circuitry 50 commands the AG PAN circuitry 82 that voice dial has been activated, puts the headset 30 into a voice recognition state, and further mutes radio signals (FM mute). In response to a recognizable voice dial command sent across the SCO link, the AG PAN circuitry 82 at line 106 informs the headset PAN circuitry 50 that voice dialing has been started in the AG 46, and the headset PAN circuitry 50 retains the headset 30 in the voice recognition state and continues to mute the radio. Line 108 depicts operation in two scenarios where voice dialing has not resulted in an established connection. Where a timer in the AG 46 times out after the voice dial procedure fails to establish a connection as requested by line 104, the AG PAN circuitry 82 informs the headset PAN circuitry 50 that voice dial procedures have been stopped. Alternatively, if the user de-activates voice dial from the headset by speaking a command or depressing a button on a headset user interface, the headset PAN unit 50 informs the AG PAN circuitry 82 to de-activate or stop voice dialing procedures. In each instance of line 108, the call indicator indicates no call is established, and the headset PAN circuitry unmutes the radio (FM unmute).

FIG. 8 is similar in layout to FIG. 7, but represents one series of command interfaces when the AG 46 supports call set-up indicators in conjunction with a handsfree headset 30. Line 110 depicts operation when the AG PAN circuitry 82 informs the headset PAN circuitry 50 of call set-up indicator=1, (a call is incoming but not yet established). The headset PAN circuitry 50 mutes the radio and sets up the headset to receive an incoming call. Line 112 depicts call set-up indicator=2 (the AG 46 is initiating a mobile call that is not yet connected, such as when a user has pressed the send button but the remote party has not yet been alerted that a call is incoming). The AG PAN circuitry 82 informs the headset PAN circuitry 50 of that set-up indicator, and the headset 30 continues to mute the radio receiver and configures for an outgoing call. Line 114 depicts call set-up indicator=3 (an outgoing call has being initiated from the AG 46 and a connection is established with the remote party's phone, but the call is not yet answered at the receiving end) sent from the AG 46 to the headset 30, wherein operation within the headset is the same as for call set-up state=2.

Once an incoming call rings at the AG 46, the ring (line 86) is as described with reference to FIGS. 4 and 7. When the call is answered and the AG 46 indicates call indicator=1 (line 98), or when a redial command is inputted at a UI 56, 58 (line 100), operation is as described with reference to FIG. 7. Line 116 represents operation where the redial procedure of line 100 has not resulted in a connected call. After the headset redial command and several rings at the receiving end of the call cause a timer in the AG 46 to expire, the AG call set-up indicator is now changed to zero (which in this case can only mean no established call). As a result, the AG PAN headset 82 sends a signal to the headset PAN circuitry 50, which unmutes the radio (FM unmute).

The remaining portions of FIG. 8 concern voice recognition aspects of the handsfree headset 30. Where voice dial is activated at line 118, the headset PAN circuitry 50 mutes the radio, puts the headset in a voice recognition state, and informs the AG PAN circuitry 82 that voice dial has been activated. In response, the AG PAN circuitry 82 informs the headset PAN circuitry 50 at line 120 that voice dial procedures have been started in the AG 46. The headset PAN circuitry 50 directs the headset to continue muting the radio and to remain configured for voice recognition.

Line 122 depicts operation in either of two scenarios where voice dialing has not resulted in an established connection. Where voice dialing procedures are interrupted by the user, such as by speaking a command or depressing a button at a UI 56, 58, the headset PAN unit 50 informs the AG PAN circuitry 82 to de-activate or stop voice dialing procedures just as in FIG. 7. Where a timer in the AG 46 times out after the voice dial procedure fails to establish a connection as requested at line 118 (i.e.: call set-up indicator=0 and call indicator=0 and voice dial procedures within the AG 46 are stopped due to an expired timer), the AG PAN circuitry 82 informs the headset PAN circuitry 50 that voice dial procedures have been stopped. In either instance represented by line 122, the call indicator indicates no call is established, and the headset PAN circuitry unmutes the radio (FM unmute).

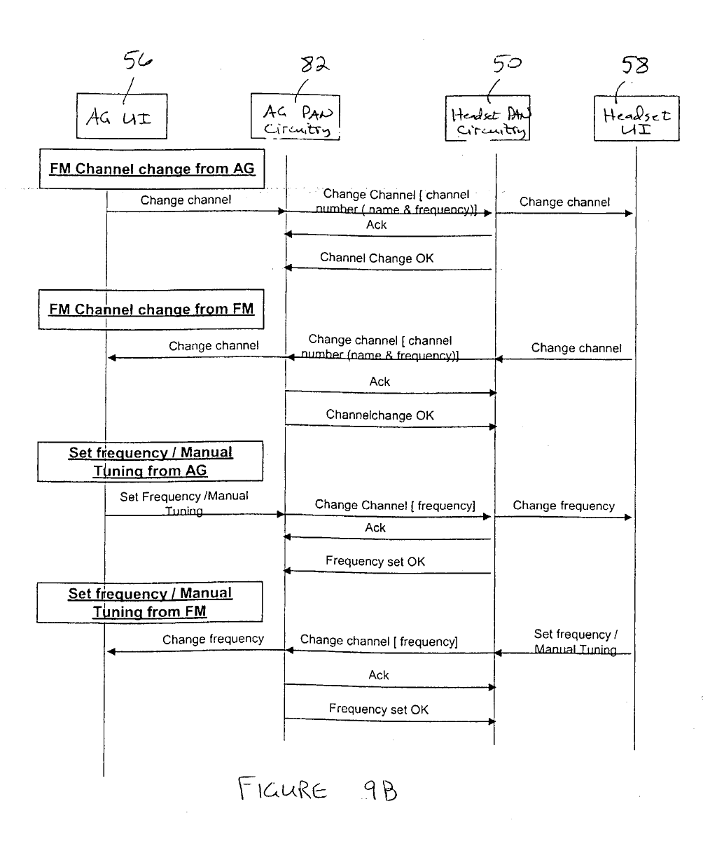

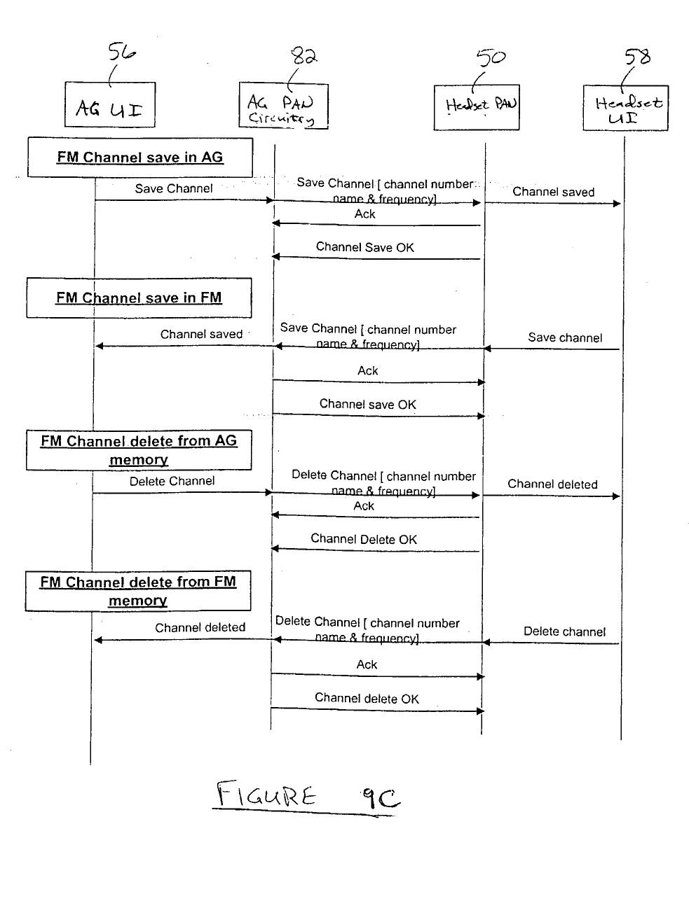

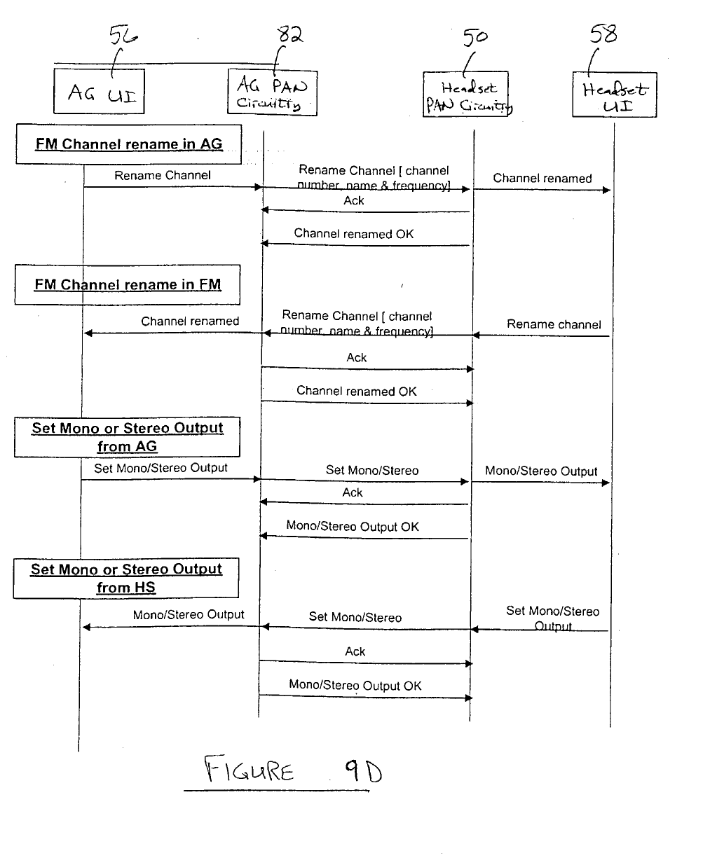

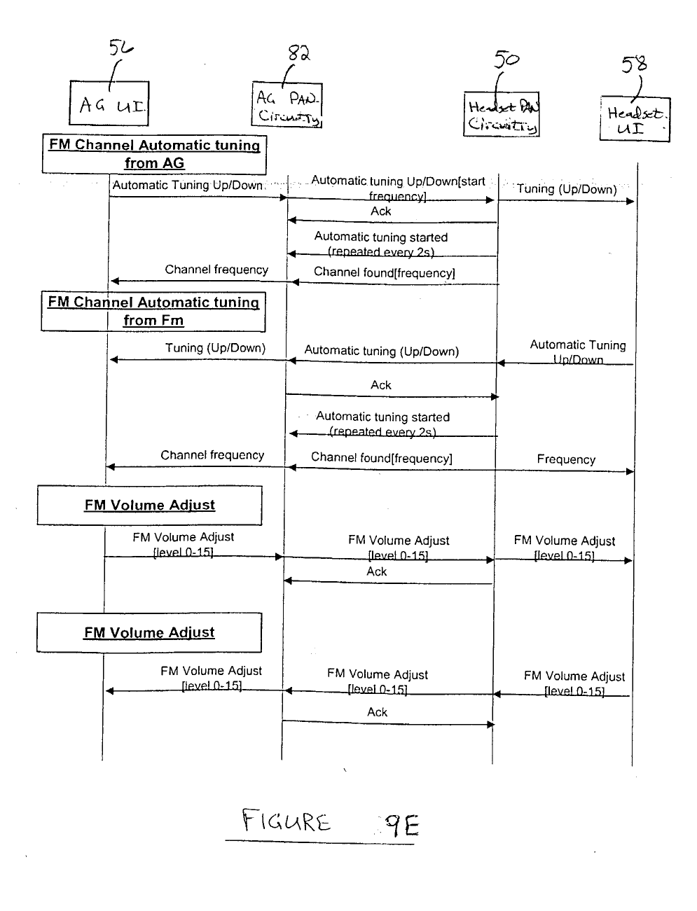

FIGS. 9A-9E are process diagrams for remote UI depicting bits of information transferred between an AG UI 56, an AG PAN circuitry 82, a headset PAN circuitry 50 that is synchronized and paired with the AG PAN circuitry 82, and a headset UI 58, which is optional. FIGS. 9A-9E may be considered as one continuous column depicting various actions at a particular UI and its effects through the communications system. These drawings will be described from left to right and top to bottom. These illustrations and the accompanying text employ terms consistent with Bluetooth protocol and FM radio reception as an example of how communications are effected.

A user selects Radio On at the AG UI 56. The AG PAN circuitry 82 takes the signal from the AG UI 56 and connects over the piconet to the headset PAN circuitry 50 via standard link manager protocol (LMP) and logical link control and adaptation protocol (L2CAP). LMP is used by link managers on either side of the piconet for link setup and control. L2CAP supports higher level protocol multiplexing, packet segmentation and reassembly, and the conveying information related to quality of service. The AG PAN circuitry 82 signals the AG UI 56 that a connection is in progress. Once the PAN connection is established, the headset PAN circuitry 50 signals the AG PAN circuitry 82 of that fact. AG PAN circuitry 82 then signals the headset PAN circuitry 50 to connect via remote UI service (whereby the AG UI may control headset functions such as the radio receiver 32) via service discovery protocol (SDP). SDP provides a means for applications to discover which services are provided for or available through a Bluetooth device, and allows applications to determine the characteristics of those available services. The AG UI then sends a parameter request, for example an FM parameters request, to determine what parameters the radio receiver 32 supports (i.e.: number of radio channels, frequency band range, channel names associated with channel numbers, stereo/mono output, presence of headset UI, memory in the headset). These could be in the SDP attribute list of a remote UI profile, and the headset PAN circuitry 50 responds with the associated information. The headset PAN circuitry 50 next sends an AG parameters request, the needed parameters that the AG 46 supports (i.e.: memory in phone for storing radio channel frequencies and names), to which the AG PAN circuitry 82 responds with the requested data. Once the above data is exchanged, the headset PAN circuitry 50 sends a “Service Connected” message to the AG PAN circuitry 82. The AG PAN circuitry 82 signals the AG UI 56 to indicate that the remote UI is connected, and signals the headset PAN circuitry 50 to turn on the radio receiver 32, preferably to a last used channel and frequency. If a headset UI 58 is present and includes a display, that display indicates that the radio is on. “FM On” is a response from the headset PAN circuitry 50 that the radio is on, and if the AG PAN circuitry 82 did not give a channel/frequency to which to tune, that information will be relayed back to the AG 46 through the AG PAN circuitry 82. If there is no memory for storing radio frequency/channel data in the handsfree headset 30, the AG PAN circuitry 82 may request channel status and volume level. The headset PAN circuitry 50 will report that status and level back to the AG PAN circuitry 82 for storage in the AG 46.

FIG. 9B depicts radio frequency changes, wherein the bolded subheadings are self-explanatory. For an FM channel change initiated at the AG UI 56 (wherein channel indicates pre-set frequency), the AG PAN circuitry 82 signals the headset PAN circuitry 50 of the requested change, which is implemented at the headset 30. If a headset UI 58 is present with a display, that display will indicate the change. The headset PAN circuitry 50 acknowledges (Ack) the request and confirms the channel change to the AG PAN circuitry 82. Where the channel change is initiated from the headset UI 58, the flow of data is reversed. Where a manual frequency (as opposed to a preset channel) is selected at the AG UI 56 or the headset UI 58, the flow of data is the same as for a channel change but the discrete frequency may be requested and confirmed rather than a pre-stored channel frequency.

FIG. 9C shows data flow similar to that described with FIG. 9B, but for saving a preset channel to (FM Channel Save in AG or FM Channel Save in FM) or deleting a preset channel from (FM Channel delete from AG memory or FM Channel delete from FM memory) the AG 46 or headset 30 memory, respectively. Similarly, FIG. 9D uses data flow similar to that described for FIG. 9B to enable renaming a channel in either the AG 46 or the headset 30 (FM Channel Rename in AG or FM Channel Rename in FM), and for setting mono or stereo output (Set Mono or Stereo Output from AG or Set Mono or Stereo Output from HS) where a user input manually enables such a change.

FIG. 9E shows automatic tuning of the preset (FM) channel from the AG 46, wherein automatic tuning up or down is selected at the AG UI 56. Automatic tuning may be scanning pre-set frequency channels, or scanning frequencies with an associated signal that exceeds a predetermined threshold, as known in the art. The AG PAN circuitry 82 transmits this request for automatic tuning to the headset PAN circuitry 50, and tuning changes are indicated at the headset UI 58. The headset PAN circuitry 50 acknowledges the request and confirms that automatic tuning has started to the AG PAN circuitry 82 (wherein frequencies are changed every 2 seconds, for example). Once a channel or frequency is found, the headset PAN circuitry 50 informs the AG PAN circuitry 82 and the result is displayed on the AG UI 56. Where FM Automatic Channel Tuning is initiated form the headset UI 58, the flow of data is reversed. Where a change of volume (preferably discrete volume levels such as 0 to 15) is selected at the AG UI 56, the AG PAN circuitry 82 signals the request to the headset PAN circuitry 50. The adjusted volume is displayed at the headset UI 58 if present, and the headset PAN circuitry 50 acknowledges the request back to the AG PAN circuitry 82. Where the (FM) volume adjust is initiated at the headset UI 58, the flow of data is reversed. The above are illustrative of the more common commands and how they may be implemented with a headset 30 of the present invention. Common to all of the descriptions in FIGS. 9A-9E, the radio receiver 32 of the headset 30 responds the same whether commands are initiated from the AG UI 56 or the headset UI 58.

Throughout this disclosure, Bluetooth is used as one example of a specific type of piconet but does not limit the invention only to Bluetooth networks. The term “radio receiver” is used in the context of AM or FM radio broadcasts, but does not limit reception to only AM or FM spectrums, or only to only publicly accessible broadcasts. For example, in some embodiments, the headset 30 may include a video receiver (e.g.: a television receiver or a computer monitor), whereby the associated video and/or audio is selectively muted as described herein. Furthermore, for a wireless mobile network capable of conveying image data, the teachings of this invention may be employed to temporarily display received images over, for example, a television signal, with or without muting and driving the speaker with audio that corresponds to the received images. While described in the context of presently preferred embodiments, those skilled in the art should appreciate that various modifications of and alterations to the foregoing embodiments can be made, and that all such modifications and alterations remain within the scope of this invention. Examples herein are stipulated as illustrative and not exhaustive.

What is claimed is:

1. A portable audio device comprising:
a first transducer for converting electrical signals to acoustic signals;
a radio receiver for receiving wireless radio transmissions and for driving the first transducer with a corresponding radio electrical signal;
circuitry for communicating over a personal area network (PAN); and
override circuitry for interrupting a signal from the radio receiver to the first transducer.

2. The audio device of claim 1 wherein the override circuitry causes the radio electrical signal to be interrupted when an audio connection between the PAN circuitry and an external apparatus is established.

3. The audio device of claim 2 wherein the override circuitry ceases to interrupt the electrical signal from the radio receiver to the first transducer when the audio connection between the PAN circuitry and the external apparatus is disconnected.

4. The audio device of claim 1 wherein the circuitry for communicating over the PAN transmits and receives signals in accordance with the Bluetooth standard.

5. The audio device of claim 1 further comprising software for controlling charge to the battery when the audio device is connected to an external power source.

6. The audio device of claim 1 wherein the radio receiver and the circuitry for communicating over the PAN are disposed on modules separate from one another.

7. The audio device of claim 1 wherein the radio receiver and the circuitry for communicating over the PAN are disposed on a common printed wiring board (PWB).

8. The audio device of claim 1 further comprising a second transducer for converting acoustic signals to electrical signals.

9. The audio device of claim 8 wherein the second transducer is connected to the circuitry for communicating over the PAN such that the circuitry for communicating over the PAN may transmit electrical signals from the second transducer.

10. The audio device of claim 8 further comprising an audio device controller that controls electrical signals to the first transducer and from the second transducer.

11. The audio device of claim 10 wherein the controller controls charging the battery when the audio device is connected to an external power source.

12. The audio device of claim 8 wherein the circuitry for communicating over the PAN causes an electrical signal from the radio receiver to the first transducer to be interrupted when an electrical signal is transmitted from the second transducer.

13. The audio device of claim 1 wherein the circuitry for communicating over the PAN transmits a parameter response related to the radio receiver.

14. The audio device of claim 13 wherein the parameter response is selected from the group: number of radio channels, frequency band range, channel number, channel name, stereo output, mono output, presence of a headset user interface, and memory.

15. The audio device of claim 1 wherein the circuitry for communicating over the PAN transmits a parameter request related to an audio gateway.

16. The audio device of claim 15 wherein the parameter request includes memory for storing radio channel frequencies in the audio gateway.

17. The audio device of claim 1 wherein the circuitry for communicating over the PAN transmits a status response related to the radio receiver.

18. The audio device of claim 17 wherein the status response is selected from the group: radio on, radio channel, radio frequency and volume level.

19. The audio device of claim 1 wherein the circuitry for communicating over the PAN transmits at least one of a command signal and an acknowledgement for confirming receipt of a command signal.

20. The audio device of claim 19 wherein the command signal is selected from the group consisting of: change channel, change frequency, save channel, delete channel, rename channel, set mono, set stereo, scan channels, scan frequencies, and adjust volume.

21. The audio device of claim 1 further comprising an audio device user interface, wherein the circuitry for communicating over the PAN transmits commands related to inputs sensed at the audio device user interface.

22. A communication system comprising a portable audio device and an audio gateway, wherein the portable audio device comprises:
a first transducer for converting electrical signals to acoustic signals;
a radio receiver for receiving wireless radio transmissions and for driving the first transducer with a corresponding electrical signal; and
headset PAN circuitry comprising
circuitry for transmitting and for receiving PAN signals,
override circuitry for interrupting a signal from the radio receiver to the first transducer, and
circuitry for driving the first transducer with an electrical signal corresponding to a PAN audio signal;
and the audio gateway comprises:
a second transducer for converting acoustic signals to electrical signals and audio gateway PAN circuitry connected to the second transducer comprising circuitry for transmitting and for receiving PAN signals.

23. The communication system of claim 22 wherein the portable audio device further comprises a third transducer for converting acoustic signals to electrical signals, and the headset PAN circuitry further comprises circuitry for transmitting electrical signals that originate at the third transducer.

24. The communication system of claim 22 wherein the PAN signals are transmitted and received in accordance with the Bluetooth standard.

25. The communication system of claim 22 wherein an input at an audio gateway user interface causes adjustments to at least one of a radio receiver volume level and a radio receiver frequency.

26. The communication system of claim 25 wherein the audio gateway user interface comprises a display that visually indicates at least one of the radio receiver volume level and the radio receiver frequency.

27. A method of transferring audio signals from an audio gateway to a physically separated audio device that comprises a radio receiver and a transducer, the method comprising:
establishing a connection over a PAN network between the audio gateway and the separate audio device,
interrupting an audio signal from the radio receiver to the transducer,
providing a different audio signal to the transducer that is related to signals received at the audio gateway over a network other than the PAN network.
